(19) United States
(12) Patent Application Publication
(10) Pub. No.: US 2020/0058279 A1
(43) Pub. Date: Feb. 20, 2020

(54) EXTENDABLE LAYERED MUSIC COLLABORATION

(71) Applicant: FoJeMa Inc., Brooklyn, NY (US)

(72) Inventor: Matthew Garrison, Brooklyn, NY (US)

(73) Assignee: FoJeMa Inc., Brooklyn, NY (US)

(21) Appl. No.: 16/542,295

(22) Filed: Aug. 15, 2019

Related U.S. Application Data
(60) Provisional application No. 62/764,823, filed on Aug. 15, 2018.

(51) Int. Cl. G10H 1/36; G10H 1/00

(52) U.S. Cl. CPC G10H 1/368; G10H 2240/325; G10H 1/0066; G10H 1/0025

(57) ABSTRACT

Techniques and mechanisms described herein facilitate extendable layered music collaboration. A production environment for production and playback of audiovisual clips is provided for display on a local client device. In response to the local client device or a remote client device associated with the environment, one or more initial audiovisual clips each comprising a segment of music is provided. A request to record one or more additional audiovisual clips is received from the local client device. The additional audiovisual clips are recorded while one or more of the initial audiovisual clips play back in real time, with the recording of the audiovisual clip including synchronization of an audio clip and a video clip. Optionally, the additional audiovisual clips are provided for playback to the local client device or one or more remote client devices.

### CROSS-REFERENCE TO RELATED APPLICATIONS

This application claims the benefit of U.S. Provisional Application No. 62/764,823 (Attorney Docket No. FOJEPOO1P) by Matthew Garrison., filed on Aug. 15, 2018 titled, “EXTENDABLE LAYERED MUSIC COLLABORATION,” which is incorporated by reference herein in its entirety and for all purposes.

### TECHNICAL FIELD

This invention relates generally to audio and audiovisual production, and more specifically to new and useful systems and methods for providing extendable layered music collaboration within an audiovisual composition, recording, and playback environment.

### BACKGROUND

Both at the consumer and the professional levels, interactive applications for music education, composition, recording, and playback are becoming an increasingly large market. Solely within rights organizations membership, there are nearly one million professional musicians licensed under ASCAP and BMI, while the actual number is likely higher when including freelance musicians, touring small and independent bands, and professionals who perform and record outside of rights organizations. In addition, the number of aspiring and non-professional musicians may be impossible to estimate, but represent a much larger pool, including music students, rock bands practicing in garages, professionals who can't afford or don't need representation, buskers, bedroom musicians, and home producers uploading to music sharing sites. There is a growing professional market for music and video production software for these audiences.

However, digital audio workstations (or “DAWs”) and video editing software are often expensive, and geared towards professionals, including Ableton Live, Final Cut Pro, and ProTools HD. They are also overwhelmingly specialized and focused. For example, Ableton Live largely focused on music production and recording, while Final Cut Pro largely focuses on video editing, with only a limited amount of overlap and workflow between the two applications. In addition, most tools currently on the market do not provide easy or robust solutions for collaboration between multiple individuals, either in the audio or visual realms. Finally, the current set of tools on the market are largely focused narrowly on producing a final, mixed-down master track or a final, completed video product, with no solution for authoring or playback tools that allow for the production or sharing of audio or video in layers, within an iterative creation and release workflow.

Thus, there is a need in the audiovisual production field to create a new and useful system and method for audiovisual composition, recording, and playback tools that allow for extendable, layered music collaboration for both professional and amateur musicians.

### BRIEF DESCRIPTION OF THE DRAWINGS

The disclosure may best be understood by reference to the following description taken in conjunction with the accompanying drawings, which illustrate particular embodiments.

FIG. 1 illustrates an example of a system 100 for providing extendable layered music collaboration within an audiovisual authoring and playback environment, performed in accordance with various techniques and mechanisms of the present invention.

FIG. 2 illustrates an example of a method for providing extendable layered music collaboration within an audiovisual authoring and playback environment, performed in accordance with various techniques and mechanisms of the present invention.

FIG. 3 illustrates a main project view 300 for an audiovisual authoring and playback environment, performed in accordance with various techniques and mechanisms of the present invention.

FIG. 4 illustrates a project view 400 of a project within an audiovisual authoring and playback environment, performed in accordance with various techniques and mechanisms of the present invention.

FIG. 5 illustrates a collaboration view 500 within an audiovisual authoring and playback environment, performed in accordance with various techniques and mechanisms of the present invention.

FIG. 6 illustrates a recording view 600 within an audiovisual authoring and playback environment, performed in accordance with various techniques and mechanisms of the present invention.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular audio and video recordings, audio and video streams, servers, media platforms, music production environments, and social media platforms. However, it should be noted that the techniques of the present invention apply to a wide variety of different content streams, servers, and environments. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Techniques and mechanisms described herein facilitate providing extendable layered music collaboration within an audiovisual authoring and playback environment. A production environment for production and playback of audiovisual clips is provided for display on a local client device. In response to the local client device or a remote client device associated with the environment, one or more initial audiovisual clips each comprising a segment of music is provided. A request to record one or more additional audiovisual clips is received from the local client device. The additional audiovisual clips are recorded while one or more of the initial audiovisual clips play back in real time, with the recording of the audiovisual clip including synchronization of an audio clip and a video clip. Finally, the additional audiovisual clips are provided for playback to the local client device or one or more remote client devices.

In various embodiments, the production environment is extendable in that both pre-recorded clips and live streams of music can be layered together in any combination and triggered for solo playback with other clips and streams muted, and additional clips and streams can be recorded and triggered. Local client devices (e.g., the user whose account is currently authorized to use the production environment) can collaborate with remote client devices (e.g., other accounts authorized remotely to use the production environment on remote client devices) by sharing clips and live streams and adding their own clips and live streams in real time. Audio and video parts are synchronized and can be expanded upon, resulting in a music playback and creation environment that is continuously moving, changing, adapting, and updating, either with music solely from a local user or with music from a combination of local users and remote users collaborating together.

Benefits

For modern musicians seeking to release music, gain exposure, and connect with audiences, several problems emerge. First, there is a problem involving the digital presentation of materials. Many musicians attempt to release a recorded album, see no interest, and give up on selling albums. The same musicians often will find their albums openly being shared for free, and without authorization, on torrent sites, peer-to-peer sharing sites, and other sources.

This unauthorized sharing of albums relies on the traditional concept of an album, with its mixed, mastered, and bounced-down master track as a final recording to be distributed to listeners. Such sharing becomes more difficult to conceptualize when this traditional concept of the album is broken down and replaced with recordings distributed in bits and pieces, with listeners being able to add their own contributions and recordings, or simply riff on individual parts of the recording, so as to capture the curiosity of the listener and have them be an invested, collaborative part of the experience of the music. It also mirrors the musician's understanding of the music, as musicians tend to layer tracks of music, sometimes one at a time, sometimes all at once. If listeners feel like they are part of the process of the creation of the record, then there is less of an impulse to share a single canonized recording and more of an impulse to participate.

In addition, adding a video component, also capable of being broken down into segments or clips that can be edited and rearranged, and distributing to the public bits and pieces promises an additional layer of atomization of and immersion in the music experience that communities and listeners can participate in.

Second, there is the problem of how musicians can collaborate together on a music project or audiovisual project. Currently, the typical method is for musicians to send files back and forth, which is cumbersome and often introduces frustrating technical problems. There are also multiple modalities with separate applications and devices that must be employed, including audio production applications, video production and editing applications, cameras, audio capture devices, and the like. A video editing application often limits you to producing video, with audio as an already-produced component you add in later. Having all of these components available as a single, streamlined, multi-modal application would simplify the ability to collaborate.

In some embodiments, a user can produce and edit audio or visual components at the spur of the moment, including improvisations on existing recordings or live streams. In various embodiments, a user can mix and master the audio, input video into the project by creating different instances (or “tracks”), and create a fully edited video with music elements. In some embodiments, a user can “subscribe” to a channel within the production environment, and receive notifications from other users who run channels that a new song, new lesson, or new clip has been made available. In some embodiments, a community or social media aspect can be present within the production environment, allowing users to exchange ideas on topics, songs, contribute material, collaborate on live performances, share material, and more. Some users may use the production environment simply to listen to music other users have shared. Some users may use the production environment to play music live, either solo or with one or more local or remote collaborators. In this sense, songs can be created and distributed which are updatable, non-destructively mutable, and continually changing.

For example, a user can record with three different players, then the user or other users can expand and add five piano players to the same recording, ten drummers, and so on. Then one or more users can select different combinations, record different parts or alternate takes, mute some parts, edit other parts, or perform any other suitable modification or addition to the song. The recording is expandable over time and mutable. The application allows users to edit music from themselves or others, insert themselves into existing pieces of music for learning and educational purposes, create wholly new music, and more.

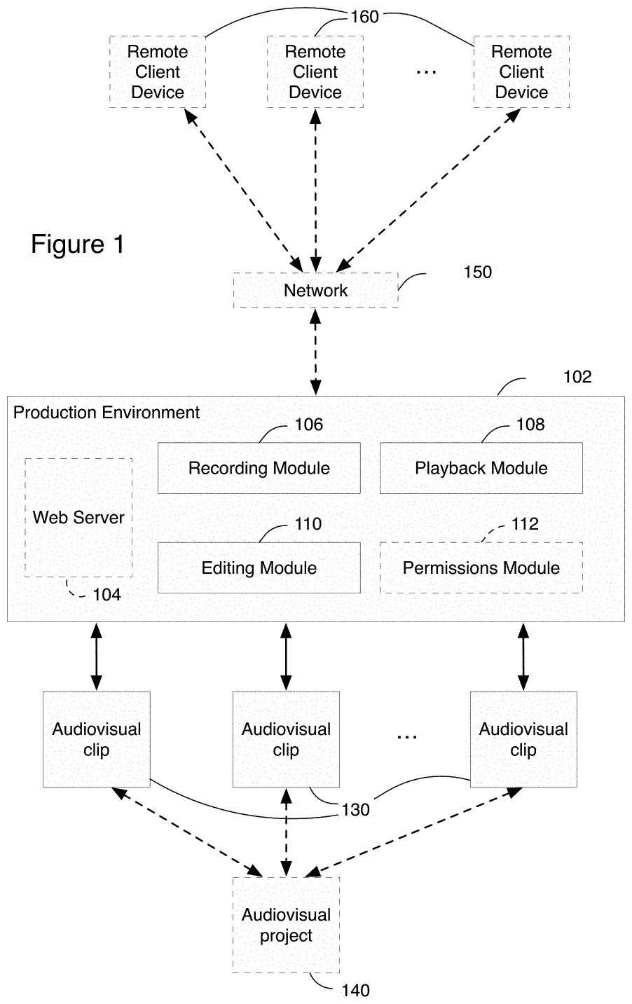

FIG. 1 illustrates an example of a system 100 for providing extendable layered music collaboration within an audiovisual authoring and playback environment, performed in accordance with various techniques and mechanisms of the present invention. As shown, system 100 can include: a production environment 102, an optional web server 104, a recording module 106, a playback module 108, an editing module 110, an optional permissions module 112, one or more audiovisual clip(s) 130, an optional audiovisual project 140, an optional network 150, and optional remote client device(s) 160.

Production environment 102 is an environment in which audiovisual projects, including music projects, video projects, or both, can be created, played back, modified, added to, removed from, or any other suitable production tasks can be performed. In a preferred embodiment, production environment 102 is an environment which combines a music production environment with a video production environment. In some embodiments, production environment 102 is primarily or solely a music production environment. In other embodiments, production environment 102 is primarily or solely a video production environment. In some embodiments, production environment 102 runs on, is built into, and/or is communicable with a local client device. Such a local client device may be a desktop computer, laptop, smartphone, tablet, VR device, wearable, or any other device capable of running and/or communicating with production environment 102. In some embodiments, production environment 102 provides a visual user interface for display on a local client device, which can be interacted with by a user of the local client device. The visual user interface can display, for example, music production elements, video production elements, playback elements, modification and permission elements, and more.

Optional web server 104 functions to provide a web server for communicating with one or more remote clients. The web server 104 may transmit and/or receive one or more messages, audio clips, video clips, audiovisual clips, or other data to or from remote clients and/or the local client device. In some embodiments, web server 104 is part of the local client device and communicates with the production environment 102.

Recording module 106 functions to generate audio and/or visual recordings within the production environment 102. In some embodiments, recordings may be created based on one or more inputs, including audio inputs from a line input, audio interface, MIDI device, OSC device, or any other suitable way of providing audio to the production environment 106. Recordings may alternatively or additionally be based on visual inputs, including a camera, smartphone, or other device capable of transmitting video data.

Playback module 108 functions to play back recorded audio clips, video clips, and/or audiovisual clips. In some embodiments, playback module plays clips on demand based on a user's interaction with the production environment. In some embodiments, playback module is configured to play a final output track, such as a “bounced down” mix of multiple clips from within a project.

Editing module 110 functions to provide editing tools and capabilities within the production environment 110. In some embodiments, editing tools may be, for example, tools for sequencing, audio manipulation (e.g., editing of pitch, speed/time, synthesis parameters, looping, etc.), MIDI and/or note data manipulation, clip selection, or any other suitable form of editing within the production environment 102. A vast variety and amount of editing features can be contemplated as suits a number of possible production environments and needs.

Optional permissions module 112 functions to allow a user of the production environment 102, such as a user of the local client device, to add, modify, or delete permissions pertaining to various aspects of the production environment 102. For example, in some embodiments, a user can add, modify, or delete permissions pertaining to audio clips, video clips, or audiovisual clips the user has recorded, or entire projects within the production environment 102. In some embodiments, permissions can relate to viewing or accessing clips or projects, editing clips or projects, collaborating with the user, creating derivative works based on clips or projects, or any other suitable permissions within the production environment 102.

Audiovisual clip(s) 130 function to present snippets, sections, excerpts, takes, or full pieces in audio and/or visual form. In some embodiments, audiovisual clip(s) may be imported from one or more sources, such as the local client device, a website, a remote repository, or other source. In some embodiments, audiovisual clip(s) are recorded in real-time or substantially real time for use within the production environment.

Optional audiovisual project 140 is a project consisting of one or more audio clips, video clips, and/or audiovisual clips. In some embodiments, the project can be saved, edited, added to, exported in one or more formats (e.g., a WAV or MP3 file), or otherwise manipulated within the production environment 102.

Optional network 150 functions to provide remote communication between the production environment 102 or a local client device running or communicable with the production environment 102 and one or more remote client devices 160. Any number of network protocols or communications standards may be contemplated for remote network communication.

Optional remote client device(s) 160 function to provide remote users with the ability to view, access, play back, edit, record, manipulate, add to, delete, or otherwise use audiovisual clips and/or projects within the production environment 102. Collaboration with remote users and privileges regarding remote users will be described in further detail below.

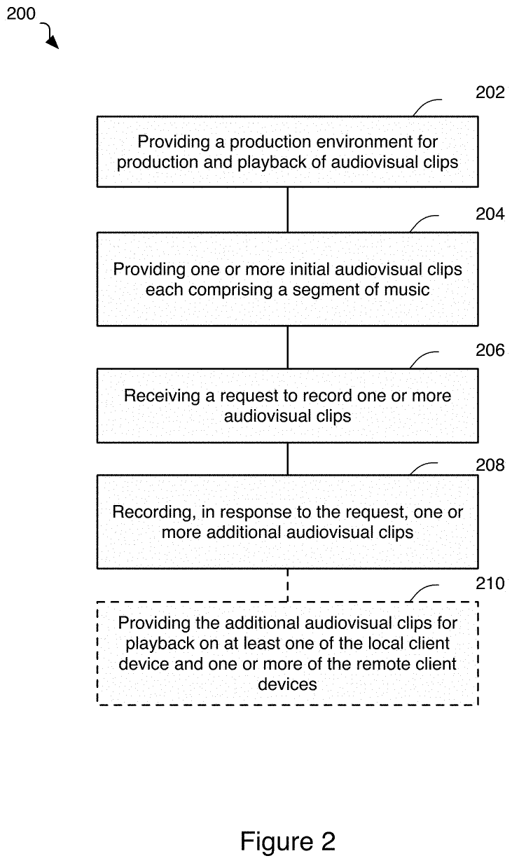

FIG. 2 illustrates an example of a method for providing extendable layered music collaboration within an audiovisual authoring and playback environment, performed in accordance with various techniques and mechanisms of the present invention.

At step 202, the system provides a production environment for the production and playback of audiovisual clips. In a preferred embodiment, a user of a local client device opens an application including or consisting of the production environment. The production environment is then displayed or otherwise provided to the user on the local client device, such as in the form of a visual user interface displayed on the client device. The production environment may be a music production environment, video production environment, audiovisual production environment, or any other suitable production environment.

At step 204, the system provides one or more initial audiovisual clips which each comprise a segment of music. In some embodiments, the initial audiovisual clips may be prerecorded, recorded in real-time or substantially real-time during the user's or remote users' interaction with the production environment, or imported from one or more sources (e.g., the local client device or a remote repository of music or video clips).

At step 206, the system receives a request to record one or more audiovisual clips. In some embodiments, the request is received from a user of the local client device interacting with the production environment. For example, a user may click on a button in the user interface within the production environment interface marked “Record”, or a button containing the visual form of a recording symbol or icon. In some embodiments, prior to interacting with the recording user interface element, a user may “arm” one or more tracks to signal that they are to be recorded. In some embodiments, the user may initiate a request to begin a recording upon the satisfying of some condition or triggering of some event. For example, the user may press a user interface button which signals the system to begin recording once the system receives notice or signal of the triggering of an event within the production environment. In varying embodiments, such an event may be, e.g., the triggering of a MIDI note, recognition of sound through a microphone, audio interface, or audio channel, recording state of a video camera being enabled, or any other suitable event within a production environment.

At step 208, the system records, in response to the request, one or more additional audiovisual clips. In some embodiments, the system records one or more additional audiovisual clips in response to the system receiving notice or signal of the triggering of an event within the production environment.

In a preferred embodiment, a recording state is enabled within the production environment, wherein any sound, video, or both on a track or channel that is designated to be recorded (or, if the user desires, all tracks or channels, or some pre-selected tracks or channels) is captured as a recording within the one or more additional audiovisual clips. For example, a user may have a synthesizer with its stereo audio outputs plugged into an audio interface, which is connected and enabled within a local client device running the production environment. The user may also have a video camera connected to the local client device. In response to the user pressing a record button, the system can begin capturing the audio from the synthesizer as well as the video from the camera into separate audio clips and video clips.

In some embodiments, the recording of the additional audiovisual clips comprises synchronizing one or more recorded audio clips and one or more recorded video clips. In the above example, after recording the separate audio clip and video clip, the system can then integrate the audio clip and the video clip into a single audiovisual clip, such that the direct audio from the synthesizer output and the direct video from the camera output can be combined.

In some embodiments, at least one of the initial audiovisual clips plays back in real time or substantially real time during the recording of the one or more additional audiovisual clips. This real time recording can allow a user to, for example, record a new part for an existing clip. As the existing clip plays back, the user can play along with a new part on top of the clip being played back.

At optional step 210, the system provides the additional audiovisual clips for playback on at least one of the local client device and one or more of the remote client devices. In some embodiments, the additional audiovisual clips are played back upon a request being received from the user to play back one or more of the additional audiovisual clips.

In some embodiments, the system provides a user interface option on the local client device to allow the user to upload the recorded audiovisual clips to a remote repository. Upon receiving a request from the local client device to upload the recorded audiovisual clips to the remote repository, the system uploads, in response to the request, the recorded audiovisual clips to the remote repository.

In some embodiments, the system additionally provides user interface options for modifying one or more user permissions settings for at least the uploaded audiovisual clips. These permissions can include, for example: permission settings to allow or restrict the ability of one or more users to modify or share the uploaded audiovisual clips, permission settings to allow or restrict the ability of one or more users to modify or share the uploaded audiovisual clips, or any other suitable permissions settings with respect to the audiovisual clips.

In some embodiments, a share access code may be generated at the request of a user. In some embodiments, the share access code can be used to share song or project content with one or more other people (users and/or non-users) with which the user wishes to share content. The system generates a new access code when a sharing button is pushed by the user. That code is then shared with other users or non-users to allow them access to the same song. In some embodiments, the other users or non-users can enter the shared code from a share menu upon logging into the production environment, or enter the shared code within a website or other space. In some embodiments, the user can control the level of permissions other invited users can have when handling the shared song. For example, a collaboration mode can allow other users to fully edit the song; a creative mode can allow other users to share the song with third parties; and a view only mode can allow others to view or access the song only, with no editing or sharing capabilities.

In some embodiments, the system associates the recorded audiovisual clips with an audiovisual project and at least one user attached to that audiovisual project. The system can receive, from the local client device, a request to create or modify permissions associated with the audiovisual project with respect to one or more users; and create or modify the permissions associated with the audiovisual project in response to the request. Such permissions can include, for example: permission to share the audiovisual project with one or more third parties, and permission to create derivative versions of the audiovisual project.

In some embodiments, the system additionally records one or more alternate audiovisual clips, and associates the alternate audiovisual clips with the additional audiovisual clips for optional playback by one or more users instead of the additional audiovisual clips. In some embodiments, the system allows for alternate performers to be swapped in or out for particular parts.

In some embodiments, the system provides, within the production environment and for display on the local client device, user interaction tools for chronologically arranging and rearranging the recorded audiovisual clips within an audiovisual piece. Such an audiovisual piece can be “bounced down” or mastered to a final recording.

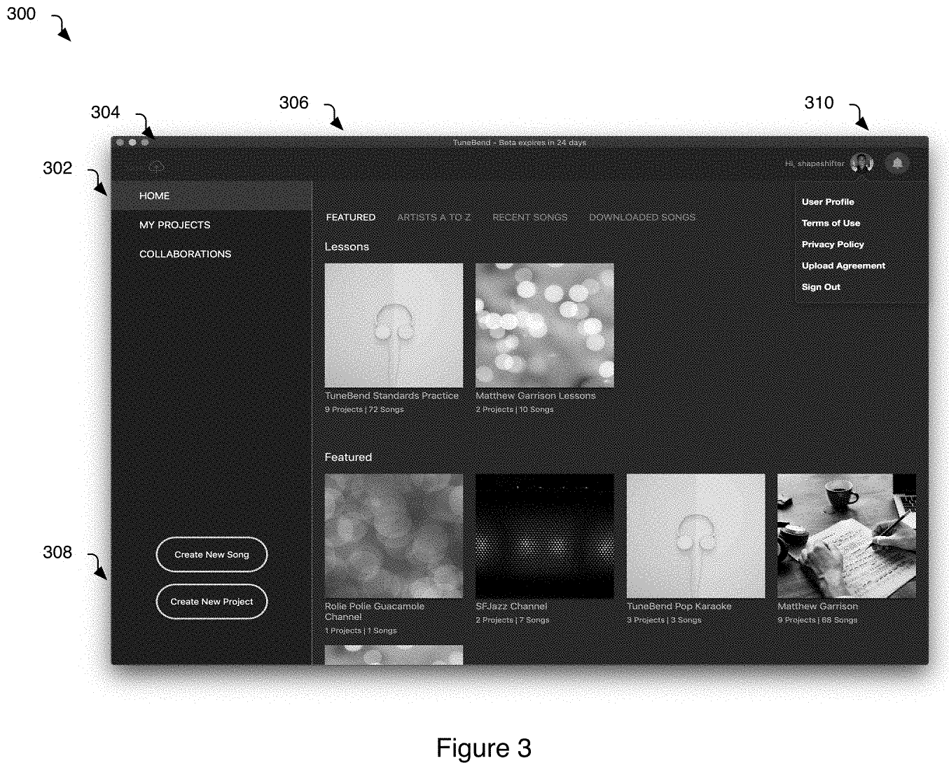

FIG. 3 illustrates a main project view 300 for an audiovisual authoring and playback environment, performed in accordance with various techniques and mechanisms of the present invention.

Within the main project view, a “HOME” section 302 is selected and visible, which represents the main landing page of the production environment upon a user authenticating and completing sign-in as a user account. In some embodiments, the “HOME” section additionally or alternatively functions as a public area where all content submitted by users can be accessed. In some embodiments, users are able to opt in to distributing and exposing their content to the public on the “HOME” page. In some embodiments, users opt in by setting their projects and/or songs to a “public” setting, at which point the content appears in the main windows of this section.

A save section 304 is visible in the upper left of the screen. In some embodiments, a “Save” button allows the user to direct the system to save a local copy of a project and/or song to the local client device. In some embodiments, an additional button, represented by, e.g., a cloud symbol, provides the user with the option to upload data to a remote cloud repository tied to the user's account. The remote cloud repository may be on a remote network server which is communicable with the production environment and/or local client device.

Across the top of the screen are navigation tabs 306 to allow for the user to quickly access and navigate to, e.g., new, featured, or sorted content. Below the navigation tabs are a number of graphical icons which represent a collection of objects. Each collection of objects contains a collection of related songs, parts, additional content, PDF charts, text, and/or any other suitable content within the production environment.

Creation buttons 308 provide the user with the options to create a new song or create a new project within the production environment. The “Create New Song” button switches the user interaction screen to a section for creating a new song, while the “Create New Project” button switches the user interaction screen to a section for creating a new project. A project can represent, e.g., a collection of songs, a single unfinished song to be edited further, or any other suitable form of project, production, or work within the production environment.

The user section 310 shows an icon with a user-selected picture representing the user. Upon clicking on the icon, a submenu appears, allowing the user to select other screens including a user profile, terms of use, privacy policy, signing out, and more. In some embodiments, the user may also navigate to a user account screen, a settings screen, a control center (e.g., for controlling permissions for various songs and/or projects), or any other suitable user-oriented section of the production environment. A notification icon is also displayed (in this example, the icon is represented as a bell), which, upon a user clicking, shows notifications. In some embodiments, notifications can include alerts to the user for when other users create or modify their projects, songs, lessons, and/or other work within the production environment.

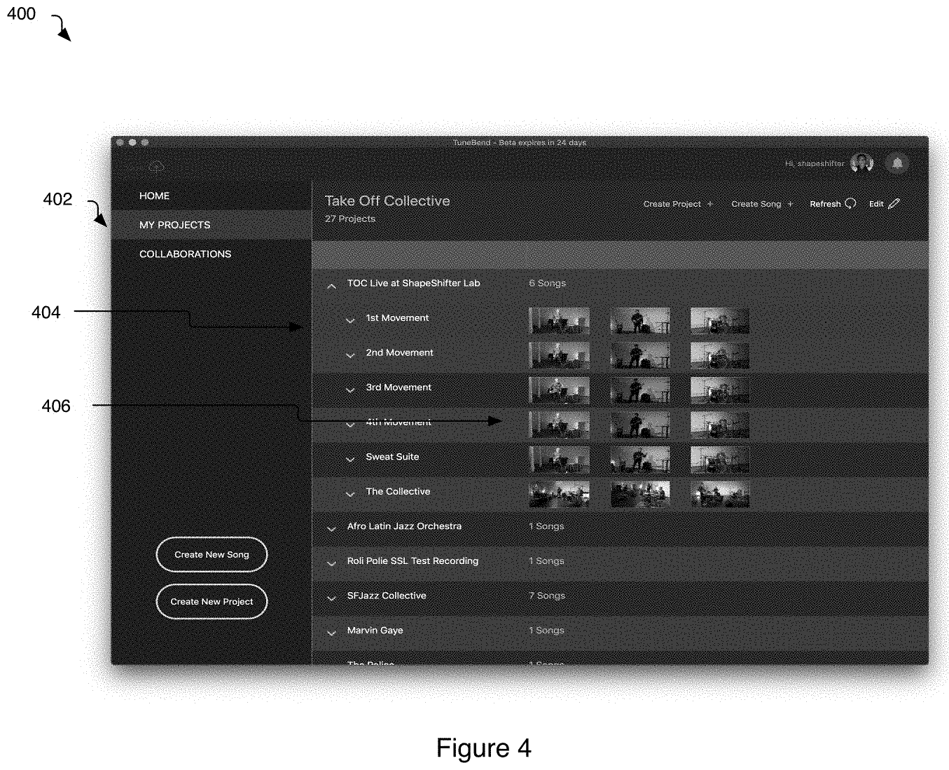

FIG. 4 illustrates a project view 400 of a project within an audiovisual authoring and playback environment, performed in accordance with various techniques and mechanisms of the present invention.

The “My Projects” view 402 is visible, as the user has navigated to this section of the production environment. The projects view shows projects and project details associated with the user, as well as songs and song details within each project. The project section 404 shows a foldable or collapsible table row for a project associated with the user, exposing all encapsulating songs that the user associated with the user account has added to this project. The clips section 406 is a visual representation of the current state of each song, showing one or more clips for each song that are initially viewable or playable. In some embodiments, alternate clips may also be viewable in this section. In some embodiments, alternate clips are greyed out or otherwise depreciated within the section to indicate that they are not primary clips in the song.

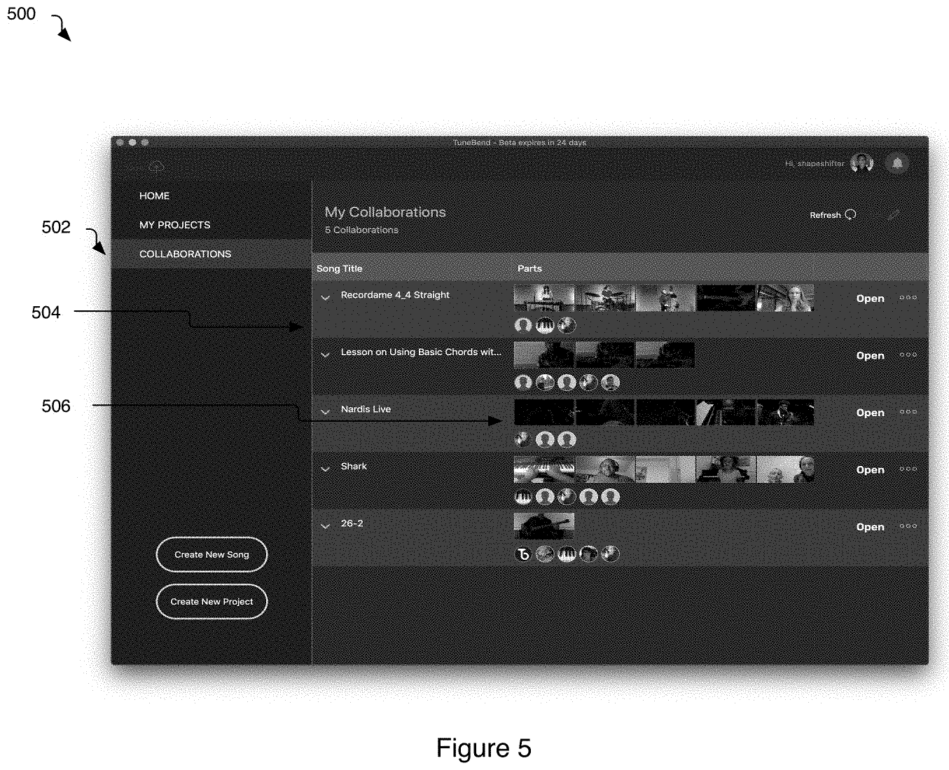

FIG. 5 illustrates a collaboration view 500 within an audiovisual authoring and playback environment, performed in accordance with various techniques and mechanisms of the present invention.

The “Collaborations” view 502 is visible, as the user has navigated to this section of the production environment. The collaborations view displays all songs to the user that are being collaborated on with respect to the user and one or more other users of the production environment (e.g., remote users operating remote devices). The user may have initiated the viewable collaboration, or may have been invited to collaborate with another user. In either case, the collaborate can appear in the collaborations view.

The song section 504 shows each song being collaborated on. For each song, a song details section 506 shows clips for the song, and smaller icons appear below the clip representing the other users who are collaborating with the user on the song. In some embodiments, a highlighted icon represents the collaborator who initiated the collaboration.

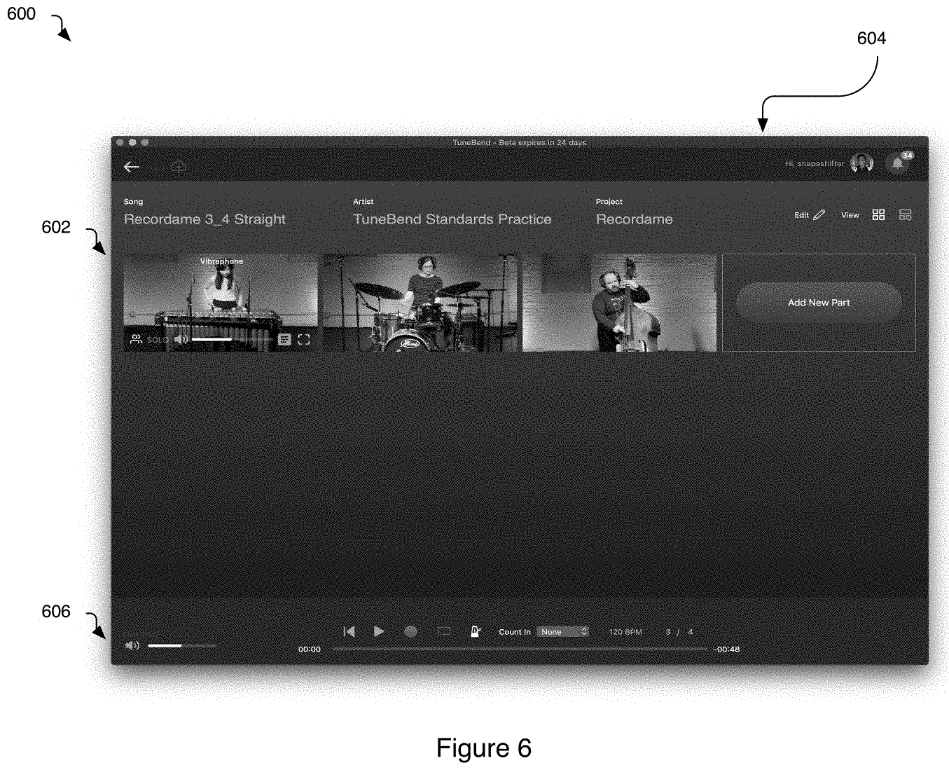

FIG. 6 illustrates a recording view 600 within an audiovisual authoring and playback environment, performed in accordance with various techniques and mechanisms of the present invention.

The recording view 600 shows a song and its parts, along with tools to record, import, edit, and playback parts. Part 602 represents a part of the song in the form of an audiovisual clip. “Add New Part” button 604 allows the user to record or import an additional part into the song. In some embodiments, collaborators with appropriate song and/or project permissions can also add new parts by recording and/or importing them. In some embodiments, if a clip already exists for a part, the user and/or other users can add swappable or alternative clips for that part.

Toolbar section 606 provides a number of editing, recording, and playback functions in an accessible manner to the user within the production environment. From left to right, the toolbar can provide features such as an audio enable/disable button, a volume control, an elapsed time indicator, a scrubbable playback timeline, a rewind button, a play button, a record button for audio and/or video, a button to loop all or some viewable parts, a click or metronome enable/disable button, a user selectable count-in (e.g., a certain number of clicks or metronome beats are played prior to the start of recording a clip), a modifiable song tempo, a modifiable song time signature, and a remaining time indicator.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method for facilitating music collaboration, comprising:
providing, for display on a local client device, a production environment for production and playback of audiovisual clips, wherein the production environment is associated with at least one or more remote client devices;
providing, in response to the local client device or a remote client device from the one or more remote client devices, one or more initial audiovisual clips each comprising at least a segment of music;
receiving, from the local client device, a request to record one or more audiovisual clips; and
recording, in response to the request, one or more additional audiovisual clips.

2. The method of claim 1, wherein the recording of the additional audiovisual clips comprises synchronizing one or more recorded audio clips and one or more recorded video clips.

3. The method of claim 1, further comprising:
providing the additional audiovisual clips for playback on at least one of the local client device and the one or more remote client devices.

4. The method of claim 1, wherein at least one of the initial audiovisual clips plays back in real time or substantially real time during the recording of the one or more additional audiovisual clips.

5. The method of claim 1, further comprising:
providing, for display on the local client device, a user interface option to upload the recorded audiovisual clips to a remote repository;
receiving a request from the local client device to upload the recorded audiovisual clips to the remote repository; and
uploading, in response to the request, the recorded audiovisual clips to the remote repository.

6. The method of claim 5, further comprising:
providing, for display on the local client device, user interface options for modifying one or more user permissions settings for at least the uploaded audiovisual clips.

7. The method of claim 6, wherein the one or more permissions settings comprises at least permission settings to allow or restrict the ability of one or more users to modify or share the uploaded audiovisual clips.

8. The method of claim 6, wherein the one or more permissions settings comprises at least permission settings to allow or restrict the ability of one or more users to modify or share the uploaded audiovisual clips.

9. The method of claim 1, further comprising:
associating the recorded audiovisual clips with an audiovisual project and at least one user.

10. The method of claim 9, further comprising:
receiving, from the local client device, a request to create or modify permissions associated with the audiovisual project with respect to one or more users; and
creating or modifying the permissions associated with the audiovisual project in response to the request.

11. The method of claim 10, wherein the permissions associated with the audiovisual project include one or more of: permission to share the audiovisual project with one or more third parties, and permission to create derivative versions of the audiovisual project.

12. The method of claim 1, further comprising:
recording one or more alternate audiovisual clips; and
associating the alternate audiovisual clips with the additional audiovisual clips for optional playback by one or more users instead of the additional audiovisual clips.

13. The method of claim 1, further comprising:
receiving, from the local client device, a request to share the recorded audiovisual clips with one or more users; and
providing, to one or more of the remote client devices, an option to access the recorded audiovisual clips.

14. The method of claim 1, further comprising:
providing, within the production environment and for display on the local client device, user interaction tools for chronologically arranging and rearranging the recorded audiovisual clips within an audiovisual piece.

15. A system comprising:
a communications interface configured to communicate with one or more remote client devices; and
a processor configured to:
provide, for display on a local client device, a production environment for production and playback of audiovisual clips, wherein the music production environment is associated with at least the one or more remote client devices;
provide, in response to the local client device or a remote client device from the one or more remote client devices, one or more initial audiovisual clips each comprising at least a segment of music;
receive, from the local client device, a request to record one or more audiovisual clips; and
record, in response to the request, one or more additional audiovisual clips.

16. The system of claim 15, wherein the recording of the additional audiovisual clips comprises synchronizing one or more recorded audio clips and one or more recorded video clips.

17. The system of claim 15, wherein the processor is further configured to:
provide the additional audiovisual clips for playback on at least one of the local client device and the one or more remote client devices.

18. The system of claim 15, wherein at least one of the initial audiovisual clips plays back in real time or substantially real time during the recording of the one or more additional audiovisual clips.

19. The system of claim 15, wherein the processor is further configured to:
provide, within the production environment and for display on the local client device, user interaction tools for chronologically arranging and rearranging the recorded audiovisual clips within an audiovisual piece.

20. A non-transitory computer readable medium having instructions stored thereon for performing a method, the method comprising:
providing, for display on a local client device, a production environment for production and playback of audiovisual clips, wherein the production environment is associated with at least one or more remote client devices;
providing, in response to the local client device or a remote client device from the one or more remote client devices, one or more initial audiovisual clips each comprising at least a segment of music;
receiving, from the local client device, a request to record one or more audiovisual clips; and
recording, in response to the request, one or more additional audiovisual clips.
